(19) United States
(12) Patent Application Publication
(10) Pub. No.: US 2018/0093696 A1
(43) Pub. Date: Apr. 5, 2018

(54) STEERING WHEEL ASSEMBLY AND HEATED STEERING WHEEL SYSTEM

(71) Applicant: FORD GLOBAL TECHNOLOGIES, LLC, Dearborn, MI (US)

(72) Inventors: Adnan Najib Dubaisi, Dearborn, MI (US); James Robert Chascsa, II, Farmington Hills, MI (US); Michael Joseph Dean, Westland, MI (US)

(21) Appl. No.: 15/282,293

(22) Filed: Sep. 30, 2016

(51) Int. Cl. B62D 1/06; H05B 3/16

(52) U.S. Cl. CPC B62D 1/065; H05B 3/16

(57) ABSTRACT

A steering wheel assembly includes an inner body, a heat sink material overlying the inner body and a heating mat overlying the heat sink material. The steering wheel assembly also includes an outer wrap overlying the heating mat. A heated steering wheel system is also disclosed.

### TECHNICAL FIELD

This document relates generally to the motor vehicle equipment field and, more particularly, to a steering wheel assembly as well as to a heated steering wheel system incorporating that steering wheel assembly.

### BACKGROUND

It is known in the art to equip motor vehicles with heated steering wheels which incorporate a resistive heating element controlled by a thermostat or other controller. Upon reaching a given temperature, the thermostat/controller shuts off power to the resistive heating element in the steering wheel. Heat is then quickly transferred through the steering wheel rim to the interior compartment atmosphere of the motor vehicle.

This document relates to a new and improved steering wheel assembly incorporating a heat sink material between the inner body of the steering wheel assembly and the heating mat of the steering wheel assembly. Advantageously, the heat sink material stores heat from the heating mat and releases it more slowly into the interior compartment atmosphere of the motor vehicle. Advantageously, the new and improved steering wheel assembly disclosed in this document maintains a more consistent steering wheel assembly temperature for added operator comfort while also reducing energy demand.

### SUMMARY

In accordance with the purposes and benefits described herein, a steering wheel assembly is provided. That steering wheel assembly comprises an inner body, a heat sink material overlying the inner body, a heating mat overlying the heat sink material and an outer wrap overlying the heating mat.

In one or more embodiments, the heat sink material may comprise a single layer of a high thermal conductive material. For purposes of this document “high thermal conductive material” means a material having a thermal conductivity equal to or greater than 204 (W/(m*K°)).

That single layer may be a solid sheet, a mesh or a sprayed mat.

The single layer of thermal conductive material may be constructed from an appropriate metal, an appropriate mineral or an appropriate composite. Appropriate metals include but are not necessarily limited to copper and aluminum. An appropriate mineral includes but is not necessarily limited to diamond, graphite or other carbon materials. Appropriate composites include various metal composites such as copper-tungsten pseudoalloy, aluminum-(silicon carbide) composite, dymalloy, and beryllium oxide in beryllium matrix. In addition, the single layer of high thermal conductive material may comprise a combination of any of the above.

The inner body may comprise polyurethane foam molded around an armature.

In one or more alternative embodiments, the heat sink material may comprise multiple layers of a high thermal conductive material having a thermal conductivity equal to or greater than 204 (W/m*K°). In such an embodiment, at least one of the layers of the multiple layers may be a solid sheet, a mesh or a sprayed mat. Further, at least one of the multiple layers of high thermal conductive material may be selected from a group of materials consisting of a metal, a mineral, a composite, copper, aluminum, diamond, graphite or other carbon material, copper-tungsten pseudoalloy, aluminum-(silicon carbide) composite, dymalloy, beryllium oxide and beryllium matrix and combinations thereof. Further, the inner body may comprise polyurethane foam molded around an armature.

In accordance with yet another aspect, a heated steering wheel system is provided. That heated steering wheel system comprises a steering wheel assembly, a power source and a controller configured to direct power from the power source to the heating mat. The steering wheel assembly includes an inner body, a heat sink material overlying the inner body, a heating mat overlying the heat sink material and an outer wrap overlying the heating mat.

The heat sink material may include at least one layer of a high thermal conductive material having a thermal conductivity equal to or greater than 204 W/(m*K°).

The at least one layer of high thermal conductive material may be selected from a group of materials consisting of a metal, a mineral, a composite, copper, aluminum, diamond, graphite or other carbon material, copper-tungsten pseudoalloy, aluminum-(silicon carbide) composite, dymalloy, beryllium oxide in beryllium matrix and combinations thereof. Further, the inner body may comprise polyurethane foam molded around an armature.

In the following description, there are shown and described several preferred embodiments of the steering wheel assembly and the heated steering wheel system incorporating that steering wheel assembly. As it should be realized, the steering wheel and heated steering wheel system are capable of other, different embodiments and their several details are capable of modification in various, obvious aspects all without departing from the steering wheel and heated steering wheel system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the steering wheel assembly and heated steering wheel system and together with the description serve to explain certain principles thereof. In the drawing figures:

FIG. 1 is an exploded perspective view of the steering wheel assembly.

FIG. 2 is a cross-sectional view of the steering wheel assembly illustrated in FIG. 1.

FIG. 3 is a detailed schematic view illustrating a heat sink material incorporating multiple layers of a high thermal conductive material.

FIG. 4 is a schematic block diagram illustrating a heated steering wheel system incorporating the steering wheel assembly of FIGS. 1 and 2.

Reference will now be made in detail to the present preferred embodiments of the steering wheel assembly and heated steering wheel system, examples of which are illustrated in the accompanying drawing figures.

### DETAILED DESCRIPTION

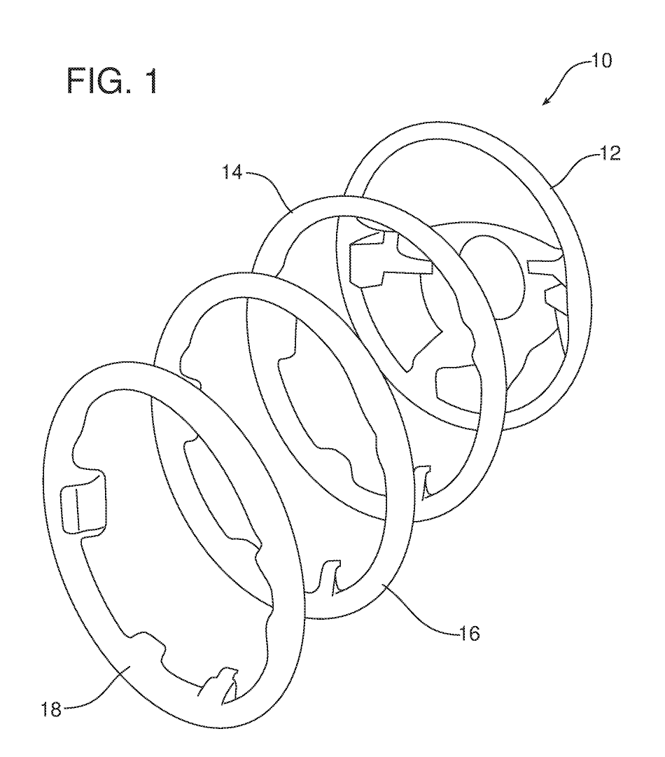

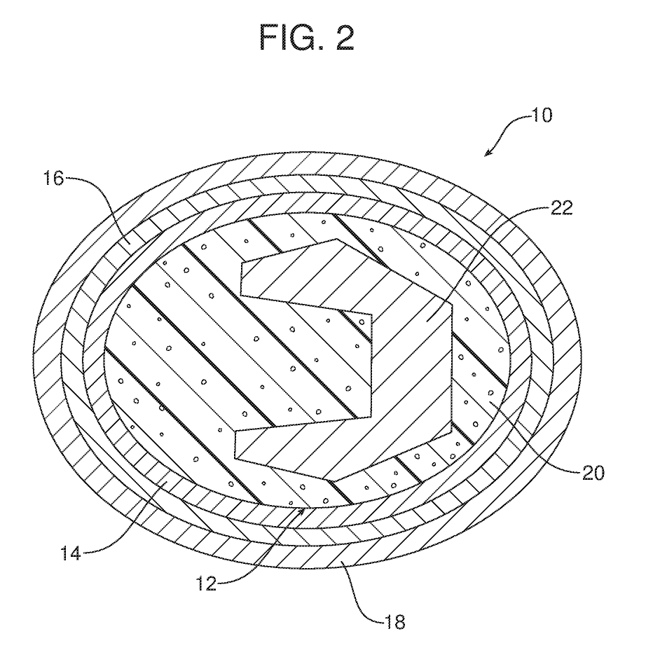

Reference is now made to FIGS. 1 and 2 illustrating a first embodiment of the steering wheel assembly 10. The steering wheel assembly 10 includes an inner body 12, a heat sink material 14 overlying the inner body 12, a heating mat 16 overlying the heat sink material and an outer wrap 18 overlying the heating mat.

More specifically, as best shown in FIG. 2, the inner body 12 of the illustrated embodiment comprises polyurethane foam 20 molded around an armature 22 made of metal or other appropriate material. As illustrated in FIG. 2, the armature 22 has a substantially U-shaped cross section. Such a cross section should be considered as exemplary and not limiting in scope. Thus, it should be appreciated that the armature 22 may assume substantially any other appropriate cross-sectional shape. As also illustrated in FIG. 2, the heat sink material 14 conforms to the shape of the inner body 12 and, more particularly, the polyurethane foam 20 and fully encompasses or encircles it.

In the embodiment illustrated in FIG. 2, the heat sink material 14 comprises a single layer of a high thermal conductive material having a thermal conductivity equal to or greater than 204 W/(m*K°). The single layer heat sink material 14 may comprise a solid sheet, a mesh or even a sprayed mat. Further, the single layer of heat sink material 14 may be made from any appropriate metal, mineral or composite material. Appropriate metals include but are not necessarily limited to copper and aluminum. Appropriate minerals include but are not necessarily limited to diamond, graphite or other carbon material such as carbon nanotubes or the like.

Appropriate composites include but are not necessarily limited to metal matrix composites such as copper-tungsten pseudoalloy, aluminum-(silicon carbide) composite, dymalloy, and beryllium oxide in beryllium matrix. Further, it should be appreciated that the single layer heat sink material 14 may be made of any one of the above materials or any combination of those materials.

More specifically, aluminum-(silicon carbide), also known as AlSiC is a metal matrix composite that consists of aluminum silicon carbide particles held in an aluminum matrix. Aluminum-(silicon carbide) composite has a high thermal conductivity on the order of 180-200 W/(m*K°) that is well-suited for incorporation into the steering wheel assembly 10.

Dymalloy is a metal matrix composite that consists of type I diamond held in an alloy matrix of 20% copper and 80% silver. Dymalloy has a very high thermal conductivity of 420 (W/m*K°) which is also well-suited for incorporation into the steering wheel assembly 10.

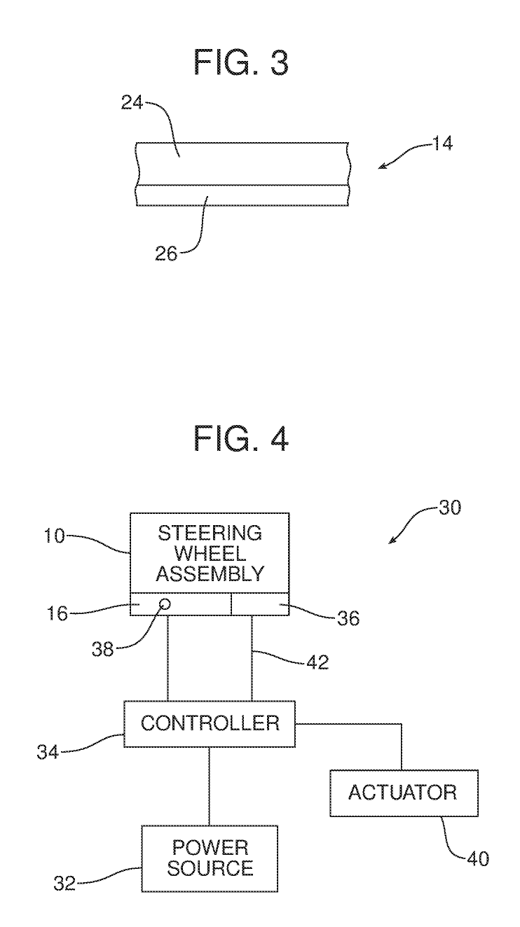

FIG. 3 is a detailed schematic illustration of an alternative embodiment of heat sink material 14 incorporating multiple layers 24, 26. The two layers 24, 26 may be constructed from the same or different materials. At least one of the two layers 24, 26 is made from an appropriate metal, an appropriate mineral or an appropriate composite material. An appropriate metal material includes, but is not necessarily limited to, copper and aluminum. An appropriate mineral material includes, but is not necessarily limited to, diamond, graphite or other carbon material such as carbon nanotubes or the like. An appropriate composite material includes, but is not necessarily limited to, metal matrix materials such as copper-tungsten pseudoalloy, aluminum-(silicon carbide) composite, dymalloy, and beryllium oxide in beryllium matrix. At least one of the layers 24, 26 may comprise any combination of these materials. While two layers 24, 26 are illustrated, it should be appreciated that the heat sink material 14 could also comprise more than two layers.

In any of the embodiments, the layers 24, 26 of the heat sink material 14 would be processed so that their surfaces are electrically non-conductive but retain their thermal conduction. Further, it should be appreciated that the layers 24, 26 are sandwiched together in a manner that allows thermal conduction in both directions. This allows the heat sink material 14 to store thermal energy or heat delivered to the steering wheel assembly 10 through the heating mat 16 as well as to release thermal energy or heat in a slow and consistent manner when the heating mat 16 is deactivated. In any multiple layer combination, the outer layer of the heat sink material 14 oriented toward the outer wrap 18 may be designed to control the flow of thermal conduction out of the steering wheel assembly 10.

The outer wrap 18 may comprise any appropriate material suited to provide an interface between the steering wheel assembly 10 and the hands of the motor vehicle operator. In one possible embodiment, the outer wrap 18 is made from leather which provides good tactile sensation and conducts a comforting warmth from the steering wheel assembly 10 into the hands of the motor vehicle operator. Of course, other appropriate materials such as alcantara could be utilized for the outer wrap 18.

Reference is now made to FIG. 4, which is a schematic block diagram of a heated steering wheel system 30. The heated steering wheel system 30 includes a steering wheel assembly 10 such as illustrated and described above in FIGS. 1-3, a power source 32 such as the primary motor vehicle battery, and a controller 34. The controller 34 may be a computing device such as a dedicated microprocessor or an electronic control unit (ECU) operating in accordance with instructions from appropriate control software. Thus, the controller 34 may comprise one or more processors, one or more memories and one or more network interfaces all communicating with each other over a communication bus.

As further illustrated in FIG. 4, the controller 34 may be connected to a thermostat 36 which monitors the temperature of the heating mat 16. As illustrated in FIG. 4, the heating mat 16 includes at least one resistance heating element 38.

When the heated steering wheel system 30 is activated as, for example, by means of the actuator 40 which may comprise a push button or the like, the controller 34 directs power from the power source 32 to the resistance heating element 38 of the heating mat 16. The heating mat 16 then begins to heat the steering wheel assembly 10. Some of that heat or thermal energy is stored in the heat sink material 14 and some of the heat generated by the heating mat 16 is conducted through the outer wrap 18 into the hands of the motor vehicle operator and into the interior atmosphere of the motor vehicle.

Once the heating mat 16 reaches a predetermined temperature, the thermostat 36 provides an appropriate signal to the controller 34 through the control line 42 and the controller deactivates the heating mat 16: that is, interrupts power from the power source 32 to the heating mat 16.

While the heating mat 16 is cycled off, the heat sink material 14 allows slow conduction of the thermal energy stored in the heat sink material 14 outwardly through the outer wrap 18 into the hands of the vehicle operator and the interior atmosphere of the motor vehicle. Advantageously, the heat sink material 14 functions to maintain the outer surface of the outer wrap 18 at a desired operating temperature comfortable to the hands of the motor vehicle operator. The stored thermal energy is conducted slowly so that a more constant temperature is maintained over a longer period of time. Since, the desired temperature is maintained at the surface of the outer wrap 18 for a longer period of time, the timeframe before the heating mat 16 needs to be cycled back on by the controller 34 is extended. Thus, the heat sink material 14 effectively allows the heated steering wheel system 30 to be operated more efficiently, lowering power requirements.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A steering wheel assembly, comprising:
an inner body;
a heat sink material overlying said inner body;
a heating mat overlying said heat sink material; and
an outer wrap overlying said heating mat.

2. The steering wheel assembly of claim 1, wherein said heat sink material is a single layer of a high thermal conductive material having a thermal conductivity equal to or greater than 204 W/(m*K°).

3. The steering wheel assembly of claim 2, wherein said single layer is a solid sheet.

4. The steering wheel assembly of claim 2, wherein said single layer is a mesh.

5. The steering wheel assembly of claim 2, wherein said single layer is a sprayed mat.

6. The steering wheel assembly of claim 2, wherein said single layer of said high thermal conductive material is selected from a group consisting of a metal, a mineral, a composite, copper, aluminum, diamond, graphite or other carbon material, copper-tungsten pseudoalloy, aluminum-(silicon carbide) composite, dymalloy, beryllium oxide in beryllium matrix and combinations thereof.

7. The steering wheel assembly of claim 6, wherein said inner body comprises polyurethane foam molded around an armature.

8. The steering wheel assembly of claim 1, wherein said inner body comprises polyurethane foam molded around an armature.

9. The steering wheel assembly of claim 1, wherein said heat sink material is multiple layers of a high thermal conductive material having a thermal conductivity equal to or greater than 204 W/(m*K°).

10. The steering wheel assembly of claim 9, wherein at least one layer of said multiple layers is a solid sheet.

11. The steering wheel assembly of claim 9, wherein at least one layer of said multiple layers is a mesh.

12. The steering wheel assembly of claim 9, wherein at least one layer of said multiple layers is a sprayed mat.

13. The steering wheel assembly of claim 9, wherein at least one of said multiple layers of said high thermal conductive material is selected from a group consisting of a metal, a mineral, a composite, copper, aluminum, diamond, graphite or other carbon material, copper-tungsten pseudoalloy, aluminum-(silicon carbide) composite, dymalloy, beryllium oxide in beryllium matrix and combinations thereof.

14. The steering wheel assembly of claim 13, wherein said inner body comprises polyurethane foam molded around an armature.

15. The steering wheel assembly of claim 9, wherein said inner body comprises polyurethane foam molded around an armature.

16. A heated steering wheel system, comprising:
a steering wheel assembly including an inner body, a heat sink material overlying said inner body, a heating mat overlying said heat sink material and an outer wrap overlying said heating mat;
a power source; and
a controller configured to direct power from said power source to said heating mat.

17. The heated steering wheel system of claim 16, wherein said heat sink material is at least one layer of a high thermal conductive material having a thermal conductivity equal to or greater than 204 W/(m*K°).

18. The heated steering wheel system of claim 17, wherein said at least one layer of said high thermal conductive material is selected from a group consisting of a metal, a mineral, a composite, copper, aluminum, diamond, graphite or other carbon material, copper-tungsten pseudoalloy, aluminum-(silicon carbide) composite, dymalloy, beryllium oxide in beryllium matrix and combinations thereof.

19. The heated steering wheel system of claim 18, wherein said inner body comprises polyurethane foam molded around an armature.

20. The heated steering wheel system of claim 16, wherein said inner body comprises polyurethane foam molded around an armature.
